(19) United States
(12) Patent Application Publication
(10) Pub. No.: US 2025/0229251 A1
(43) Pub. Date: Jul. 17, 2025

(54) ANTI-BACTERIAL AND ANTI-AMMONIA BEADS

(71) Applicants: Nanyang Technological University, Singapore (SG); Wageningen Universiteit, Wageningen (NL)

(72) Inventors: Bee Eng Mary CHAN, Singapore (SG); Penghui ZHANG, Singapore (SG); Remko Marcel BOOM, Wageningen (NL)

(21) Appl. No.: 18/853,675

(22) PCT Filed: Apr. 11, 2023
(86) PCT No.: PCT/SG2023/050245

§ 371 Date: Oct. 2, 2024

(30) Foreign Application Priority Data
Apr. 11, 2022 (SG) 10202203705R
Apr. 11, 2022 (SG) 10202203708S

(51) Int. Cl. B01J 20/18; A01K 61/00; B01J 20/26; B01J 20/32

(52) U.S. Cl. CPC B01J 20/18; A01K 61/00; B01J 20/262; B01J 20/3217; B01J 20/3238; B01J 20/3272; B01J 20/3282; B01J 20/3289; B01J 20/3295

(57) ABSTRACT

Disclosed herein is a composite material in the form of a bead, the beads are either formed from: a polyethyleneimine, graphene oxide, and zeolite nanoparticles, where the bead has a hollow core and a layered shell structure comprising a plurality of layers of graphene oxide and a plurality of layers of polyethyleneimine, where any two layers of graphene oxide are separated by a layer of polyethyleneimine and the zeolite nanoparticles are intercalated between the plurality of graphene oxide layers, and the polyethyleneimine is crosslinked by a negatively charged crosslinking agent; or a polyethyleneimine and graphene oxide, where the bead has a hollow core and a layered shell structure comprising a plurality of layers of graphene oxide and a plurality of layers of polyethyleneimine, where any two layers of graphene oxide are separated by a layer of polyethyleneimine, and covalent bonds are formed between the polyethyleneimine and the graphene oxide to crosslink the polyethyleneimine to the graphene oxide. Also disclosed herein are methods of using the composite material and its manufacture.

### FIELD OF INVENTION

The current invention relates to composite materials in the form of beads suitable for use in aquaculture, their use therein and their method of manufacture.

### BACKGROUND

The listing or discussion of a prior-published document in this specification should not necessarily be taken as an acknowledgement that the document is part of the state of the art or is common general knowledge.

In coming decades, sustainable access to proteins for the growing human population may require the application of novel technologies in the farming of aquatic species. Ocean fish and shellfish are being depleted and aquaculture is now rapidly increasing. Recirculating aquaculture systems (RAS) are commonly employed as they allow intensification. In RAS, the water quality is of vital importance to fish survival and growth. The presence of pathogenic bacteria is problematic due to their effect on fish growth rate and loss through mortality and possible negative effects on the quality of harvested fish meat. Some bacteria (such as Group B streptococcus) can also be transmitted to humans via raw fish. The banning of antibiotics for prophylactic purposes in aquaculture makes it even more challenging to control bacterial pathogens in aquaculture water. In a typical RAS, about 90% of water is recycled back to the fishpond after the water has undergone disinfection, usually with an energy-intensive method such as UV irradiation or ozone exposure. UV irradiation of bacteria is energy intensive, can cause a change in the taste of the fish water, and may corrode equipment. Ozone and its reaction products can be toxic to the fish and therefore need to be quantitatively removed again before reintroducing the water to the aquaculture ponds. Free-standing materials (non-dissolving in water with monolithic structure) with reduced energy requirements but high antibacterial activities are needed to economically meet the higher water quality standards required for intensification in RAS. An important consideration or constraint is that the antibacterial water treatment should not cause toxicity to the fish. Materials of this kind would also be highly useful for suppression of bacterial proliferation during transportation of live fish across long distances.

Other main concerns of water quality for RAS are the concentrations of organic waste and total ammonia (NH₃+NH₄⁺) nitrogen (TAN), which are from unconsumed feed and fish excretion. TAN is due to excretions from fish and is toxic to most fish species; its monitoring and control is essential for good fish yield in RAS. Various methods of TAN removal have been studied, including biofilter, nitrification, air stripping, ion exchange, adsorption, etc., but these methods suffer from problems such as environmental regulations on discharge, high energy consumption, high economic cost, and limited adsorption capacity.

Due to its naturally availability and cost effectiveness, zeolite, an aluminosilicate mineral with anionic microporous frameworks, is a commonly used selective adsorption material for the removal of ammonium ion (NH₄⁺) in the aquaculture industry. According to the NH₃/NH₄⁺ equilibrium and base ionization constant (K_{b}=[NH₄⁺][OH⁻]/[NH₃]=1.77×10⁻⁵), most of NH₃ (>90%) excreted from the fish metabolism will be converted into NH₄⁺ in normal aquaculture environment, i.e. NH₃ in ppm level and pH is near neutral (Table 1). Therefore, the removal of NH₃ or NH₄⁺ is also called removal of total ammonia nitrogen (TAN) in such condition. Although zeolite can selectively and effectively remove TAN, it does not remove pathogenic bacteria; and its adsorption capacity is limited if used in its natural stone form without further treatment. Further, zeolite should not be ingested by the fish.

TABLE 1
The theoretical ammonia and ammonium concentration
in a given initial ammonia concentration after reached
equilibrium using base ionization constant.

| Initial NH₃ | | | | NH₄⁺ at | | NH₃ at |
|---|---|---|---|---|---|---|
| conc. | | pH | [OH⁻] | equilibrium | | equilibrium |
| DI water | | 6.85 | 7.096 × 10⁻⁸ | N.A. | | N.A. |
| 2 | ppm | 6.86 | 7.261 × 10⁻⁸ | 1.86 | ppm | 0.04 ppm |
| 4 | ppm | 7.09 | 1.243 × 10⁻⁷ | 3.83 | ppm | 0.17 ppm |
| 8 | ppm | 7.06 | 1.160 × 10⁻⁷ | 7.94 | ppm | 0.06 ppm |
| 16 | ppm | 7.10 | 1.272 × 10⁻⁷ | 15.87 | ppm | 0.13 ppm |
| 32 | ppm | 7.10 | 1.281 × 10⁻⁷ | 31.73 | ppm | 0.27 ppm |

Although graphene oxide (GO) exhibits some degree of antibacterial activity attributed to physical penetration into cell membranes induced by sharp edges of GO nanosheets, which is followed by destructive extraction of large amount of phospholipids due to the hydrophobic nature of GO, its practical application as an antibacterial agent is still limited due to the relatively lower antibacterial efficiency and its toxicity threatening environment and human health.

Cationic polymers such as polyethylenimine (PEI) have been used for inactivation of bacteria but are quite toxic to fish. Zou et al. reported a diffusion driven-Layer By Layer (dd-LBL) method to assemble GO nanosheets using branched polyethyleneimine (bPEI) into porous three-dimensional (3D) GO/bPEI macrobeads which are a few millimeters in diameter, and large enough to not be ingested by fish hatchlings (Zou, J. & Kim, F., Nat. Commun. 2014, 5, 5254). Nevertheless, while Zou et al.'s GO/bPEI macrobeads can potentially inactivate bacteria, bPEI will leach out from the macrobeads, resulting in toxicity to the fish. For use in RAS, the beads should not leach any toxic material.

Therefore, there exists a need for new robust macroscale beads with excellent antibacterial activity and no toxicity for aquaculture.

### SUMMARY OF INVENTION

It has been surprisingly found that non-leaching macroscale (e.g. a few mm in diameter) cationic antibacterial beads are useful for suppression of bacteria in fish culture, without causing toxicity to the desired aquatic organisms.

Aspects and embodiments of the invention will now be discussed by reference to the following numbered clauses.

1. A composite material in the form of a bead, comprising:
a polyethyleneimine;
graphene oxide; and
zeolite nanoparticles, wherein:
the bead has a hollow core and a layered shell structure comprising a plurality of layers of graphene oxide and a plurality of layers of polyethyleneimine, where any two layers of graphene oxide are separated by a layer of polyethyleneimine and the zeolite nanoparticles are intercalated between the plurality of graphene oxide layers; and
the polyethyleneimine is crosslinked by a negatively charged crosslinking agent.

2. A composite material in the form of a bead, comprising:
a polyethyleneimine; and
graphene oxide, wherein:
the bead has a hollow core and a layered shell structure comprising a plurality of layers of graphene oxide and a plurality of layers of polyethyleneimine, where any two layers of graphene oxide are separated by a layer of polyethyleneimine; and
covalent bonds are formed between the polyethyleneimine and the graphene oxide to crosslink the polyethyleneimine to the graphene oxide.

3. The composite material according to Clause 1, wherein the weight to weight ratio of the graphene oxide to the zeolite nanoparticles is from 1:1 to 1.4:1, such as about 1.33:1.

4. The composite material according to any one of the preceding clauses, wherein the weight to weight ratio of the polyethyleneimine to graphene oxide is from 1:1 to 1.4:1, such as about 1.36:1.

5. The composite material according to any one of Clause 1, Clause 3 and Clause 4, as dependent upon Clause 1, wherein the zeta potential of the composite material is from +19 to +28 mV.

6. The composite material according to any one of Clause 1, Clause 3 and Clauses 4 to 5 as dependent upon Clause 1, wherein the composite material has an ammonia adsorption capacity of from 7 to 19 mg/g, such as about 8.24 mg/g.

7. The composite material according to Clause 2 and Clause 4 as dependent upon Clause 2, wherein the zeta potential of the composite material is from +27 to +39 mV.

8. The composite material according to any one of the preceding clauses, wherein the polyethyleneimine is a branched polyethyleneimine.

9. The composite material according to any one of Clause 1 and Clauses 3 to 6 and 8, as dependent upon Clause 1, wherein the negatively charged crosslinking agent is hyaluronic acid.

10. Use of a composite material according to any one of Clauses 1 to 9 in aquaculture.

1. A method of aquaculture comprising the steps of:
(a) providing an aquaculture medium; and
(b) placing a plurality of beads of a composite material according to any one of Clauses 1 to 9 into the aquaculture medium.

12. A method of manufacturing a composite material according to Clause 1 and Clauses 3 to 6 and 8, as dependent upon Clause 1, wherein the method comprises the steps of:
(i) providing a mixture comprising a suspension of graphene oxide and zeolite nanoparticles in a liquid;
(ii) adding a plurality of droplets of polyethyleneimine to the mixture to provide beads comprising graphene oxide, zeolite nanoparticles and polyethyleneimine; and
(iii) ionically crosslinking the polyethyleneimine in the beads with a negatively charged crosslinking agent to provide the composite material.

13. The method according to Clause 12, wherein the weight to weight ratio of graphene oxide to zeolite nanoparticles in the liquid is from 1:2 to 2:1, such as 1:1.

14. The method according to Clause 12 or Clause 13, wherein the negatively charged crosslinking agent is hyaluronic acid.

15. A method of manufacturing a composite material according to Clause 2 and Clauses 4, 7 and 8, as dependent upon Clause 2, wherein the method comprises the steps of:
(i) providing a mixture comprising a suspension of graphene oxide in a liquid;
(ii) adding a plurality of droplets of polyethyleneimine to the mixture to provide beads comprising graphene oxide and polyethyleneimine; and
(iii) covalently crosslinking the polyethyleneimine in the beads to the graphene oxide with a crosslinking agent to provide the composite material.

16. The method according to any one of Clauses 12 to 15, wherein the weight to weight ratio of the graphene oxide to polyethyleneimine is from 2:1 to 1:2, such as about 1.19:1.

17. The method according to Clause 15 or Clause 16, as dependent upon Clause 15, wherein the crosslinking agent is a carbodiimide (e.g. 1-ethyl-3-(3-dimethylaminopropyl)carbodiimide).

### DRAWINGS

FIG. 1 depicts (a) schematic experimental setup and the illustration of the crosslinked GO/bPEI (C-GP) beads preparation process. Step I involves diffusion-driven Layer by Layer (dd-LBL) process. Step II (illustrated in scheme b) is a crosslinking reaction using 1-ethyl-3-(3-dimethylaminopropyl)carbodiimide (EDC)/N-hydroxysuccinimide (NHS) chemistry.

FIG. 2 depicts (a) digital photo of raw beads in a puddle of graphene oxide (GO) suspension after the bead formation reaction. (b) Cross-section of an as-prepared bead showing the hollow-core structure with a wall thickness of ˜1 mm. (c) Digital photo of results of a larger-scale synthesis (80 beads). (d) The bead diameter increases with increased reaction time. (e) Mechanical strength analysis (loading rate: 2 mm/min); crosslinking greatly enhances the mechanical strength of the beads. (f) 3 freeze-dried C-GP beads (9.7 mg total mass) supporting a 100 g standard weight without crushing.

FIG. 3 depicts cross-section scanning electron microscopy (SEM) images of (a-c) raw GO/bPEI (R-GP) bead and (d-f) C-GP bead show that both of them have a hollow-core and multi-layer shell structure, (c) and (f) are magnifications of the highlighted regions in (b) and (e), respectively. Layered and porous network is also seen in high magnification Field Emission Scanning Electron Microscopy (FESEM) image (g) of C-GP beads. Energy dispersive spectroscopy (EDS) elemental mapping of (h) carbon, (i) nitrogen and (j) oxygen indicates homogeneous distribution of C, N, and O, and (k) is the corresponding map sum spectrum.

FIG. 4 depicts (a) FESEM image of exterior surface of C-GP bead and the corresponding Energy Dispersive X-Ray (EDX) elemental maps of (b) carbon, (c) oxygen, (d) nitrogen, (e) layer elemental image, and (f) map sum spectrum confirming the presence of bPEI in the bead external surface.

FIG. 5 depicts that the (a) Fourier-transform infrared-attenuated total reflectance (FTIR-ATR) spectra of GO, bPEI, R-GP, and C-GP indicate the formation of amide groups. (b) X-ray photoelectron spectroscopy (XPS) surveys confirm the presence of nitrogen in R-GP and C-GP beads. (c) High-resolution spectra of N 1 s of R-GP and C-GP beads indicate that most of the nitrogen content is primary amines from residual bPEI. (d) Zeta potential of GO, bPEI, and beads at the concentration of c.a. 0.5 mg/mL in water.

FIG. 6 depicts (a) ultraviolet-visible (UV-vis) spectra of GO, bPEI, and C-GP beads. The C-GP spectrum contains the superposed features of the constituents' (GO, bPEI) spectra. (b) X-ray diffraction (XRD) patterns of GO, R-GP, and C-GP beads. (c) Raman spectra of GO, R-GP, and C-GP beads.

FIG. 7 depicts (a) thermogravimetric analysis (TGA) and (b) corresponding derivative weight curves of GO, bPEI, and C-GP beads obtained in nitrogen atmosphere.

FIG. 8 depicts (a) relative viability of 3T3 cells with extraction solution of mixture of Dulbecco's Modified Eagle Medium (DMEM) medium and intact R-GP and C-GP beads (1 bead/mL) or finely ground bead dispersion (˜1000 μg/mL) after incubation for 24 h. Data for each group was replicated 3 times, and column values and error bars indicate the mean values and standard errors (SE), respectively. (b) Micrographs of zebrafish embryos (6 hours post fertilization, 6 hpf) with and without beads added at different exposure times and their corresponding phenotypic observations photographed after dechorionation with a pair of sharp tweezers. There were 20 zebrafish embryos for each experimental group and the survival rate is listed in Table 3.

FIG. 9 depicts phenotypic observations of zebrafish embryos exposed 72 h to various amounts of beads. (d-f) and (g-i) are enlargements of the heads and tails of (a-c), respectively.

FIG. 10 depicts representative micrographs of zebrafish larvae exposed to (a) 0 bead, (b) 1 bead, and (c) 10 beads for 72 h.

FIG. 11 depicts adsorbed contamination and eggshells after zebrafish embryos were dechorionated.

FIG. 12 depicts (a) time-dependent antibacterial activities of R-GP and C-GP beads during incubation with bacteria solution for 5 h. Logarithmic bacterial count were measured at 0.5, 1, 3, and 5 h. Data for each time point was triplicated, and data points and error bars in the curves indicate the mean values and SE, respectively. (b) Effect of repeated use/regeneration on antibacterial efficacy of R-GP and C-GP beads in 1 h incubation with bacteria. FESEM images of E. coli treated with (c-d) no bead [control] and (e-f) C-GP; (c-d) scale bar is 1 μm, (e-f) scale bar is 5 μm. For (a) and (b): two beads were incubated with E. coli (10⁸ CFU/mL, 10 mL) at 250 rpm shaking speed at 37° C.

FIG. 13 depicts high-performance liquid chromatography (HPLC) detected negligible bPEI leached from C-GP beads during 3-day immersion in water.

FIG. 14 depicts SEM images of the C-GP beads surface after challenge with E. coli, (a) before and (b) after washing with cetyltrimethylammonium bromide (CTAB) and DI water. Scale bar: 20 μm.

FIG. 15 depicts FESEM images of the E. coli treated with R-GP beads.

FIG. 16 depicts that (a) freeze dried C-GP beads (˜1.2 mg/each) can rapidly adsorb different dye solutions (50 mg/L, 50 μL). (b) Adsorption of hexane (dyed with Sudan I) floating on water by C-GP beads. (c) Visual appearance of the aquarium water quality with and without beads after culturing 20 adult zebrafishes for 10 days. Each group had only one tank. (d) Optical density (OD) measurements of water cloudiness, and water samples for each group were collected from 3 different parts of the tank (corner, surface, and bottle) at day 10. Columns and error bars indicate the mean values and SE, respectively.

FIG. 17 depicts adsorption capacities of freeze-dried C-GP beads for various chemicals and organic solvents.

FIG. 18 depicts (a) size distribution of zeolite nanoparticles in GO suspension; the inset is an FESEM image showing that the zeolite powder is nano-scale. (b) Cross-section photo shows that C-ZGP bead has a hollow-core structure. (c) TGA curves of zeolite, C-GP, and C-ZGP obtained in nitrogen atmosphere. (d) Layered EDX mapping images of carbon, oxygen, nitrogen, silicon, and alumina elements and (e) the corresponding map sum spectrum. (f) Relative viability of 3T3 cells exposed 24 h to DMEM extractions of C-GP and C-ZGP beads (1 bead/mL). Data for each time point was triplicated and column values indicate the mean values. (g) Micrograph of zebrafish embryos or larvae exposed to 10 C-ZGP beads at 1 day post exposure (dpe); the dark spheres (indicated by arrows) are the C-ZGP beads. (h) The zebrafish embryo circled in (g) under look up tables (LUTs) rainbow channel shows that the zebrafish embryos were developing normally.

FIG. 19 depicts (a) schematic of the C-ZGP beads preparation process. (b) Zeta potential of GO, zeolite, C-GP, and C-ZGP at the concentration of c.a. 0.5 mg/mL in water. (c) FESEM image of the surface of C-ZGP beads. (d) Micrograph of zebrafish embryos or larvae exposed to 10 C-ZGP beads at 5 dpe. (e) Micrograph of highlighted zebrafish larva in (d); under LUTs rainbow channel, organs such as heart, swim bladder, yolk, otolith, and notochord, eye, and etc., are clearly visible. (f) Antibacterial activities of C-GP and C-ZGP beads after 1 h and 3 h incubation with bacteria. Data for each time point was triplicated and columns indicate the mean values. Evaluation of TAN adsorption over (g) 4 h and (h) 24 h by different materials, using API® ammonia test kit. (i) is the ammonia color/concentration card. Note: the labels C, P-Z, 2, 5, 10, 20, and B stands for control, pristine zeolite (75.8 mg), 2 C-ZGP beads (3.8 mg), 5 C-ZGP beads (9.4 mg), 10 C-ZGP beads (18.9 mg), 20 C-ZGP beads (37.8 mg), and 20 C-GP beads (35.6 mg), respectively, tested with 10 mL TAN solution.

FIG. 20 depicts (a) FESEM image of the surface of C-ZGP beads, and (b) lower magnification of FESEM image of C-GP beads.

FIG. 21 is a digital photo showing the large-scale synthesis of C-ZGP beads.

FIG. 22 depicts schematic illustration of the hypothesis of ammonia adsorption by zeolite.

### DESCRIPTION

Composite materials in the form of beads with a number of surprising properties have been prepared. These beads may be used in the suppression of bacteria in fish culture and may be formed using a layer-by-layer growth technique to provide beads that have one or more of good mechanical stability, antibacterial performance and ammonia adsorption capacity.

Thus, in a first aspect of the invention, there is provided a composite material in the form of a bead, comprising:
a polyethyleneimine;
graphene oxide; and
zeolite nanoparticles, wherein:
the bead has a hollow core and a layered shell structure comprising a plurality of layers of graphene oxide and a plurality of layers of polyethyleneimine, where any two layers of graphene oxide are separated by a layer of polyethyleneimine and the zeolite nanoparticles are intercalated between the plurality of graphene oxide layers; and
the polyethyleneimine is crosslinked by a negatively charged crosslinking agent.

In embodiments of the first aspect of the invention, one or more of the following may apply:
(aai) the weight to weight ratio of the graphene oxide to the zeolite nanoparticles may be from 1:1 to 1.4:1, such as about 1.33:1;
(aaii) the zeta potential of the composite material may be from +19 to +28 mV;
(aaiii) the composite material may have an ammonia adsorption capacity of from 7 to 19 mg/g, such as about 8.24 mg/g; and
(aaiv) the negatively charged crosslinking agent may be hyaluronic acid.

It will be appreciated that any suitable negatively charge crosslinking agent may be used herein and that hyaluronic acid is only an example of the possible materials that may be used in embodiments of the invention.

In a second aspect of the invention, there is provided a composite material in the form of a bead, comprising:
a polyethyleneimine; and
graphene oxide, wherein:
the bead has a hollow core and a layered shell structure comprising a plurality of layers of graphene oxide and a plurality of layers of polyethyleneimine, where any two layers of graphene oxide are separated by a layer of polyethyleneimine; and
covalent bonds are formed between the polyethyleneimine and the graphene oxide to crosslink the polyethyleneimine to the graphene oxide.

In embodiments of the second aspect, the composite material may not include zeolite nanoparticles and/or a negatively charged crosslinking agent.

In embodiments of the second aspect of the invention, the zeta potential of the composite material may be from +27 to +39 mV.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

In embodiments of the first and second aspects of the invention, one or both of the following may apply:
(bbi) the weight to weight ratio of the polyethyleneimine to graphene oxide may be from 1:1 to 1.4:1, such as about 1.36:1; and
(bbii) the polyethyleneimine may be a branched polyethyleneimine.

The composite materials disclosed herein may have good biocompatibility with mammalian and vertebrate aquatic life. Without wishing to be bound by theory, it is believed that this biocompatibility is achieved through the fact that the composite materials, in the form of beads, are crosslinked to prevent or at least significantly prevent the leaching of polyethyleneimine. When used herein, the term “crosslinking” may refer to the covalent attachment of graphene oxide to polyethyleneimine. In addition, the term “crosslinking” may also refer to ionic crosslinking between polyethyleneimine and a negatively charged crosslinking agent and/or between polyethyleneimine and zeolite nanoparticles.

The composite materials disclosed herein have good antibacterial properties, as fleshed out in the examples section hereinbelow. In addition, the composite materials also have the ability to adsorb organic materials in an aqueous environment and may therefore assist in reducing the build-up of organic waste in an aquatic system (e.g. a RAS). In addition, the composite materials of the first aspect of the invention may also be able to adsorb ammonia from an aqueous environment, as described in more detail in the examples section below. The composite materials may also exhibit significant mechanical strength. For example, the composite materials disclosed herein may be able to support over 10,000 times their weight while maintaining their structural integrity.

The high porosity and mechanical stability of the composite material beads make them suitable for adsorption of organic matter and toxic components with high adsorption efficiency and good recyclability. A single, freeze-dried bead can adsorb a droplet of aqueous dye solution within 5 min of contact; this is probably due to its highly porous structure and high hydrophilicity. In addition, the beads showed outstanding adsorption behavior and capability towards various organic solvents and chemicals such as hexane, DMF, chlorobenzene, etc., with adsorption capacity in the range of 13.8 to 39.0 times the bead mass. As such, the composite material beads disclosed herein have potential for applications requiring facile and rapid removal of organic matter. Without wishing to be bound by theory, it Is believed that at least some of this ability to adsorb organic matter may be due to the porous structure of the composite material beads.

The composite material beads disclosed herein may have a size that prevents them from being ingested by fish (e.g. the composite material beads may have a millimetre-scale size, such as from 1 to 20 mm, such as from 5 to 10 mm). As will be appreciated, the size of the beads may be determined by the size of the organism (e.g. fish) that is intended to be cultured, meaning that the ranges listed here are only guides and may be varied to match the organism in question to prevent ingestion.

The composite materials disclosed herein are useful in aquaculture. Thus, in a third aspect of the invention, there is disclosed use of a composite material as described herein in aquaculture. Also, in a fourth aspect of the invention, there is disclosed a method of aquaculture comprising the steps of:
(a) providing an aquaculture medium; and
(b) placing a plurality of beads of a composite material as described herein into the aquaculture medium.

The aquaculture medium may be used in the farming of any suitable animal, such as a fish (e.g. a zebrafish).

The composite material beads disclosed herein can be readily regenerated through a simple washing step.

Thus, the composite materials of the first and/or second aspects of the invention may be used separately or together in aquaculture. Further details of how the composite materials may be used in aquaculture and the method mentioned here may be found in the examples section below.

As will be appreciated, any suitable number of the composite material beads of the first and/or second aspect of the invention may be placed into the aquaculture medium. The number may be readily determined by the skilled person based on the volume of the aquaculture medium and other suitable factors, such as the length of time that the medium will be used for, the density of the organism to be raised etc.

In a further aspect of the invention, there is provided a method of manufacturing a composite material according to the first aspect of the invention and any technically sensible combination of its embodiments, the method comprising the steps of:
(i) providing a mixture comprising a suspension of graphene oxide and zeolite nanoparticles in a liquid;
(ii) adding a plurality of droplets of polyethyleneimine to the mixture to provide beads comprising graphene oxide, zeolite nanoparticles and polyethyleneimine; and
(iii) ionically crosslinking the polyethyleneimine in the beads with a negatively charged crosslinking agent to provide the composite material.

Any suitable weight to weight ratio of graphene oxide to zeolite nanoparticles may be used in the liquid. For example, the weight to weight ratio of graphene oxide to zeolite nanoparticles in the liquid may be from 1:2 to 2:1, such as 1:1. In embodiments of the invention, the negatively charged crosslinking agent may be hyaluronic acid.

In a further aspect of the invention, there is provided a method of manufacturing a composite material according to the second aspect of the invention and any technically sensible combination of its embodiments, the method comprising the steps of:
(i) providing a mixture comprising a suspension of graphene oxide in a liquid;
(ii) adding a plurality of droplets of polyethyleneimine to the mixture to provide beads comprising graphene oxide and polyethyleneimine; and
(iii) covalently crosslinking the polyethyleneimine in the beads to the graphene oxide with a crosslinking agent to provide the composite material.

In embodiments of the above method, any suitable crosslinking agent that can assist in the formation of an ester and/or an amide bond may be used. For example, the crosslinking agent may be a carbodiimide (e.g. 1-ethyl-3-(3-dimethylaminopropyl)carbodiimide). This carbodiimide may be used alone or in combination with a suitable co-reactant, such as N-hydroxysuccinimide.

In embodiments of the methods of manufacture disclosed herein, any suitable weight to weight ratio of the graphene oxide to polyethyleneimine may be used herein. For example, the weight to weight ratio of the graphene oxide to polyethyleneimine may be from 2:1 to 1:2, such as about 1.19:1.

The composite material beads disclosed herein have negligible toxicity and excellent antibacterial activities and adsorption capacities. They can be readily obtained from a two-step process involving: I) a facile self-assembly of GO nanosheets into a hollow-core macrostructure, followed by II) a crosslinking reaction step to prevent leaching of bPEI. The non-leachable beads show excellent biocompatibility toward 3T3 cells and zebrafish embryos and larvae (as demonstrated in the examples below). Crosslinking also improves the mechanical strength of the beads. The large size (millimeter) scale of the beads is important for prevention of ingestion by fish. These beads are durable and can be easily regenerated by a simple washing step; their antibacterial activity is preserved over at least 10 use/regeneration cycles without apparent performance decline. The amine-group-rich polyethyleneimine (e.g. a branched polyethyleneimine), which may be homogeneously distributed and conjugated on the GO surface, acts as not only as the driving force in the self-assembly process but also as the active component for eradicating bacteria. The antibacterial activity is good, with over 99.9% killing against E. coli in 30 min. The combination of cationic polyethyleneimine (e.g. a branched polyethyleneimine) and hydrophobic GO endows the beads with enhanced adsorption capacity for various forms of organic matter.

Another advantage of these free-standing beads is that they can be easily handled and do not require any supporting equipment for functioning and are effective and quick in their actions. These bacteria-, organic waste- and ammonia-removal beads which are non-toxic to the zebrafish can potentially be used in urban high-density Recirculating Aquaculture System (RAS) and in the transportation of fishes across long distances. For application in RAS with larger fish, the beads could be made larger or could be enclosed in containers or cartridges which permit water passage but prevent fish access.

Further aspects and embodiments of the invention are listed in the following numbered Statements.
1. An antibacterial bead (C-GP) comprising
   a) Graphene oxide (GO); and
   b) Branched polyethylenimine (bPEI);
      wherein GO and bPEI are crosslinked.
2. The bead according to Statement 1, wherein GO and bPEI are crosslinked via 1-Ethyl-3-(3-dimethylaminopropyl)carbodiimide (EDC) and N-Hydroxysuccinimide (NHS) coupling.
3. The bead according to Statement 1 or 2, wherein the bead has an average diameter of between 1 mm and 10 mm.
4. Use of the antibacterial bead (C-GP) according to Statements 1-3 in aquaculture.
5. An antibacterial bead (C-ZGP) with ammonia absorption properties comprising
   a) Graphene oxide (GO);
   b) Branched polyethylenimine (bPEI); and
   c) Zeolite nanoparticles
   wherein GO, bPEI and the zeolite nanoparticles are crosslinked.
6. The bead according to Statement 5, wherein GO and the zeolite nanoparticles are crosslinked via hyaluronic acid.
7. The bead according to Statement 5 or 6, wherein the bead has an average diameter of between 1 mm and 10 mm.

Use of the antibacterial bead (C-GP) according to Statements 5-7 in aquaculture.

The form factor is important—the large size (millimeter) of the beads is important for prevention of ingestion by fish. The cationic bPEI acts not only as the complexing agent for the negatively charged GO but also as the antibacterial component. The crosslinking between bPEI and GO prevents significant leaching of bPEI, which is toxic.

Aspects and embodiments of the invention will now be described by reference to the following non-limiting embodiments.

### EXAMPLES

### Materials

N,N-Dimethylformamide (DMF, 99.8%), branched polyethylenimine (bPEI, M_{w}=750,000, Mₙ=60,000, 50 wt %), dimethyl sulfoxide (DMSO, 99.9%), glutaraldehyde solution (25% in H₂O), ethanol (99.8%), ammonia solution (NH₃, 2.0 M in methanol), tricaine (0.4% in Holtfreter's buffer), trifluoroacetic acid (TFA), acetonitrile (MeCN), Sudan I, CTAB detergent, hexane, oleic acid, styrene, m-xylene, tetrahydrofuran (THF), chlorobenzene, toluene, E3 medium, and phosphate-buffered saline (PBS) were purchased from Sigma Aldrich. 3-(4,5-Dimethylthiazoyl-2-yl)-2,5-diphenyl tetrazolium bromide (MTT) was purchased from Alfa Aesar. Hyaluronic acid sodium salt (HA, M_{w}=1,100,000, 96%) and pristine zeolite particles were purchased from Santa Cruz Biotechnology, Inc. and Seachem Laboratories (USA), respectively. Ammonia test kit was purchased from API®. All the water used in this study, if not mentioned, is deionized (DI) water. DI water (resistivity >15 MΩ·cm) used in this study was produced by a Merck Millipore Integral 3 water purification system.

Escherichia coli 8739 (EC, ATCC 8739) strain and 3T3 fibroblast cells (ATCC CRL-1658) were purchased from American Type Culture Collection (ATCC). Lysogeny Broth Agar (LB Agar, BD Difco™), Mueller Hinton Broth (MHB, BD Difco™) and PBS buffer (10 mM, pH=7.4) were autoclaved before use. DMEM high glucose with L-glutamine, fetal bovine serum (FBS), penicillin-streptomycin (100×), and trypsin-EDTA (0.25%) were purchased from Thermo Fisher Scientific. For 3T3 cells culture, DMEM was prepared with 10% FBS and 1% penicillin-streptomycin.

### Analytical Techniques

Field Emission Scanning Electron Microscopy with Energy Dispersive X-Ray Spectroscopy (FESEM-EDX) Elemental Mapping

The morphology and elemental distribution of the samples were recorded with a scanning electron microscope (SEM, JEOL JSM-6701F) and a field-emission scanning electron microscope (FESEM, JEOL-6700F) equipped with an energy dispersive X-ray analyzer (EDX).

### XRD

Wide-angle XRD data (Bruker D2 Phaser, Cu Kα radiation (1.54 Å)) were collected at room temperature with the 2e scan range set between 5° and 40°.

### Raman Spectroscopy

Raman spectra were recorded on a Raman spectrometer (Renishaw InVia Reflex) using 514 nm laser excitation.

### XPS

XPS was performed with an ESCALAB MK-II spectrometer (VG Scientific Ltd).

### FTIR-ATR

A FTIR (Nicolet 5700) with ATR accessory was used to analyze the chemical compositions of the as-prepared samples.

### UV-vis Spectroscopy

UV-vis absorption spectra were recorded on a UV-2600i spectroscopy (Shimadzu, Japan).

### General Procedure for the Preparation of Zeolite Nanoparticles (ZNPs)

Commercial zeolite stones (Seachem Laboratories, USA) were ground into fine powder using a ball milling machine (Fritsch) for 6 h with a speed of 600 rpm.

### Example 1. Preparation of Graphene Oxide (GO) Suspension

GO was synthesized using a modified Hummers method (Liu, S. et al., ACS Nano 2011, 5, 6971-6980). The as-prepared GO was washed by centrifuging several times and dialysis for one week. The purified GO was then re-dispersed in DMF/water (8:1, v:v) to obtain a GO suspension; the suspension also contained 0.1 mM EDC/NHS.

### Example 2. Preparation of R-GP and C-GP Beads

To add other functionality such as total ammonia nitrogen (TAN) adsorption, it would be desirable to change the formulation employed for the dd-LBL method to incorporate additional target functionalities while ensuring non-leachability.

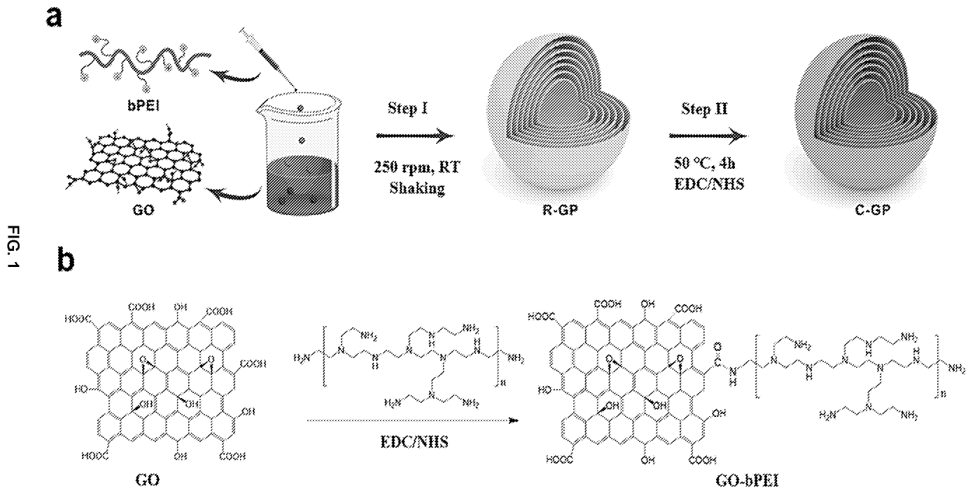

We demonstrate herein a facile method for the preparation of crosslinked GO/bPEI (C-GP) beads (FIG. 1) with excellent antibacterial activity and no toxicity for suppression of bacteria in fish culture. Raw GO/bPEI (R-GP) macroscale beads were made by the dd-LBL process (FIG. 1a, step I) via a facile self-assembly process. The cationic bPEI component was then crosslinked with GO via carbodiimide chemistry (FIG. 1a, step II), so that the cationic bPEI polymer acts not only as the complexing agent for the negatively charged GO but also as the antibacterial component. Therefore, the beads were formed by the dd-LBL process using GO substrate and bPEI, and were stabilized by post-assembly crosslinking process in which carboxyl groups on the GO were crosslinked with amine groups on the bPEI using EDC/NHS chemistry.

### R-GP Beads

In general, bPEI droplets (20 wt % in DI water, ˜8.4 mg/each droplet) were added into GO suspension with a specified concentration of 10.0 mg/mL in a 50-mL beaker using a syringe with a needle (30G×½). Then, the beaker was shaken at 250 rpm for a specified time of 3 h with an orbital shaker. After the self-assembly process, the beads were removed with tweezers and washed by immersion in DI water. The resulting “raw” GO/bPEI beads are denoted R-GP.

### C-GP Beads

The R-GP beads were then crosslinked with a simple heating treatment. Typically, 50 R-GP beads were added into 10 mL of 0.1 mM EDC/NHS solution (in ethanol). The reaction was maintained for 5 hours at 50° C. The crosslinked beads were washed by sonication for 10 min in ethanol and then in DI water to remove any residual reactant. The resulting crosslinked GO/bPEI beads are denoted C-GP.

### Results and Discussion

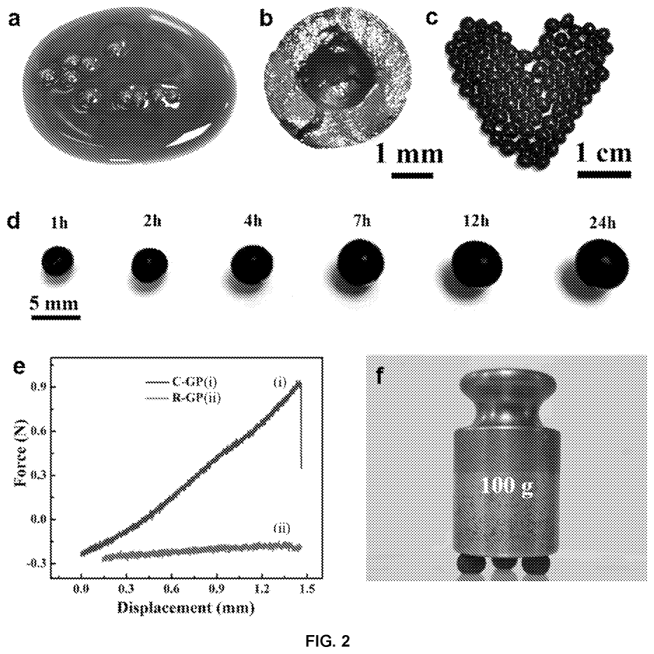

The C-GP preparation process is schematically illustrated in FIG. 1a. In a typical preparation process, bPEI solution droplets (20 wt % in DI water) with a mass of c.a. 8.4 mg/droplet were dropped into a GO suspension (10 mg/mL). The suspension containing bPEI droplets was then shaken using an orbital shaker at 250 rpm at room temperature for a specified time (e.g. 3 h) to produce “raw” graphene oxide/PEI beads (R-GP). The R-GP beads were then crosslinked (by reaction between the R—COOH groups of GO and the —NH₂ groups of bPEI) using carbodiimide chemistry (FIG. 1b), resulting in crosslinked graphene oxide-polyethylenimine (C-GP) beads with a hollow-core and layered-shell structure (FIGS. 2a-b). Due to the facile preparation method, it is very easy to scale up the process and make C-GP beads in large quantities (FIG. 2c). In addition, the diameter of C-GP beads can be tuned by controlling the shaking time (FIG. 2d).

### Example 3. Characterization of R-GP and C-GP Beads

The R-GP and C-GP beads prepared in Example 2 were characterized.

### TGA

The bead composition was examined with TGA (SDT Q600) after complete drying of the bead samples to remove water.

### Contact Angle Measurements

Contact Angle Analyzer (Kruss, DSA25) was used to measure the water contact angle of the as-prepared beads.

### Mechanical Properties

Mechanical testing machine (Instron, USA) with a loading rate of 2 mm/min was used to measure the mechanical properties of the as-prepared beads.

### Zeta Potentials

Zetasizer Nano-ZS (Malvern Panalytical) was used to measure the zeta potentials.

### Results and Discussion

The uncrosslinked “raw” beads seem to be rather ductile and deformable while the mechanical strength was enhanced strongly after crosslinking (FIG. 2e); freeze-dried C-GP beads can support over 10,000 times their weight while maintaining their structural integrity, as shown in FIG. 2f.

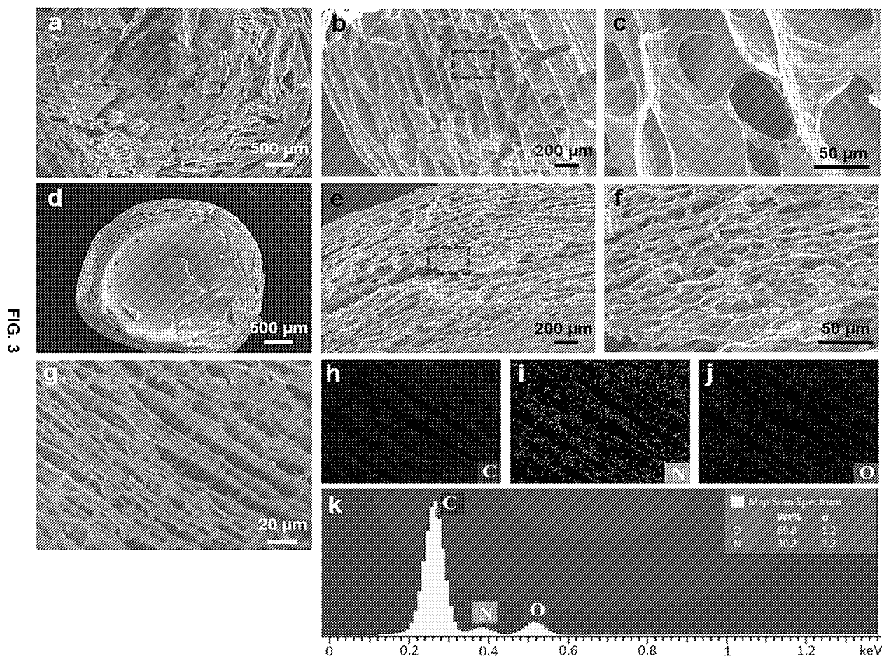

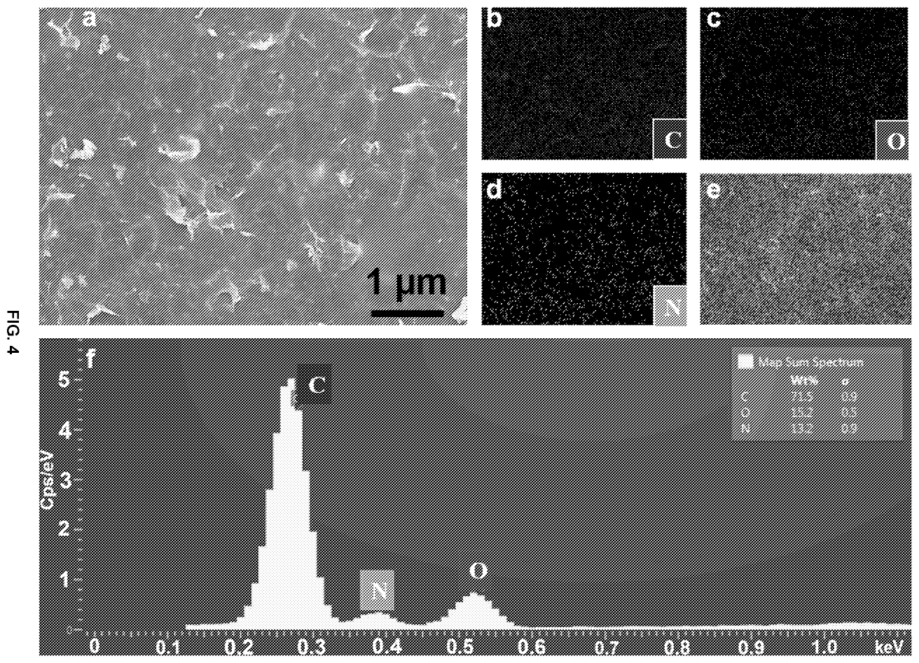

The microstructure of as-prepared R-GP and C-GP beads was investigated by SEM. The bead shell, which is several hundred micrometers thick, consists of highly porous self-assembled GO nanosheet layers (FIGS. 3a-f). In R-GP beads, which are not cross-linked, there are void spaces between GO layers of about 60 μm or larger (FIGS. 3b-c). In C-GP beads, the inter-GO void size and layer spacing are significantly smaller, in the range 10 to 20 μm (FIGS. 3e-f). The smaller inter-GO space of C-GP beads compared to the R-GP beads may result from the crosslinking between GO and bPEI which hindered the creation of larger ice crystals during the freeze-drying process before SEM imaging. FESEM-EDX elemental mapping technique (FIGS. 3g-k) was conducted to examine the element distribution of the cross-section of C-GP beads. The elements carbon, nitrogen and oxygen are widely and homogeneously distributed within the layered porous network and also on the external surface of the bead (FIG. 4), suggesting that the bPEI diffused uniformly over the GO nanosheets. The homogeneous distribution of bPEI may make its surface super-hydrophilic; this property was confirmed with dynamic contact angle measurements which show that the water droplet spreaded completely onto the curved bead surface within 3 s.

The crosslinking between bPEI and GO was investigated with various techniques. In the FTIR-ATR spectra of GO (FIG. 5a), the peaks at 1730 and 1623 cm⁻¹ are due to C═O (carbonyl) and C═C (aromatic) stretching, respectively. The R-GP beads have a small shoulder at 1730 cm⁻¹ due to the carbonyl group that is present in the —COOH group. For the C-GP beads, the carbonyl peak at 1730 cm⁻¹ almost vanished after the crosslinking, while a peak at 1647 cm⁻¹ (corresponding to amide bond stretching) appeared. Furthermore, the C-GP spectrum has two peaks located at 2821 and 2948 cm⁻¹, which are attributed to the symmetric and asymmetric stretching modes of methylene groups (C—H) in bPEI (Ren, T. et al., Polym. Chem. 2012, 3, 2561-2569; Chen, B. et al., J. Mater. Chem. 2011, 21, 7736-7741; and Roy, S. et al., ACS Appl. Mater. Interfaces 2015, 7, 3142-3151). These results confirm the crosslinking of GO with bPEI.

To further confirm the chemical composition, XPS was conducted for the samples before and after the crosslinking reaction (FIGS. 5b-c). Both the R-GP and the C-GP beads have three prominent wide-scan XPS peaks (FIG. 5b) centered at 285, 398, and 532 eV, which correspond to C1s, N1s, and O1s, respectively, corroborating their chemical compositions. As shown in FIG. 5c, after crosslinking, the high-resolution N1s spectrum of the C-GP can be well resolved into peaks located at 399.6, 401.2, and 402.5 eV, which are respectively ascribed to free amine (—NH₂), protonated amine (—N⁺), and amide (CO—NH) (He, H. et al., Sci. Rep. 2017, 7, 3913). Compared with the R-GP spectrum, the appearance in the C-GP spectrum of an amide group at 402.5 eV confirms the crosslinking reaction that produced amide in C-GP bead. The combination of the ATR-FTIR and XPS analyses shows that a stable crosslinking between GO and bPEI is formed by the carboxyl-amine reaction and the ionic complexation effect (Yuan, Z. et al., Sens. Actuators B Chem. 2016, 234, 145-154).

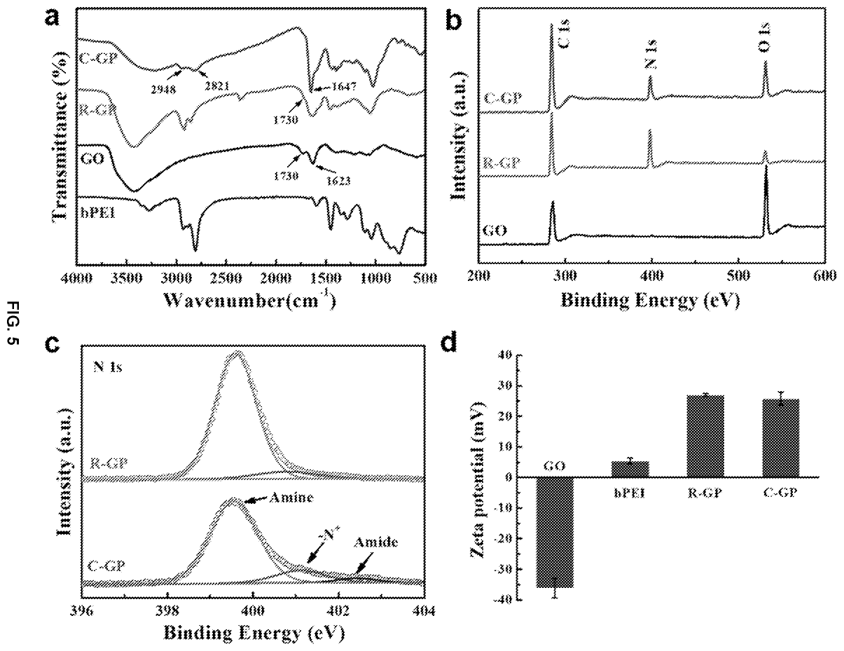

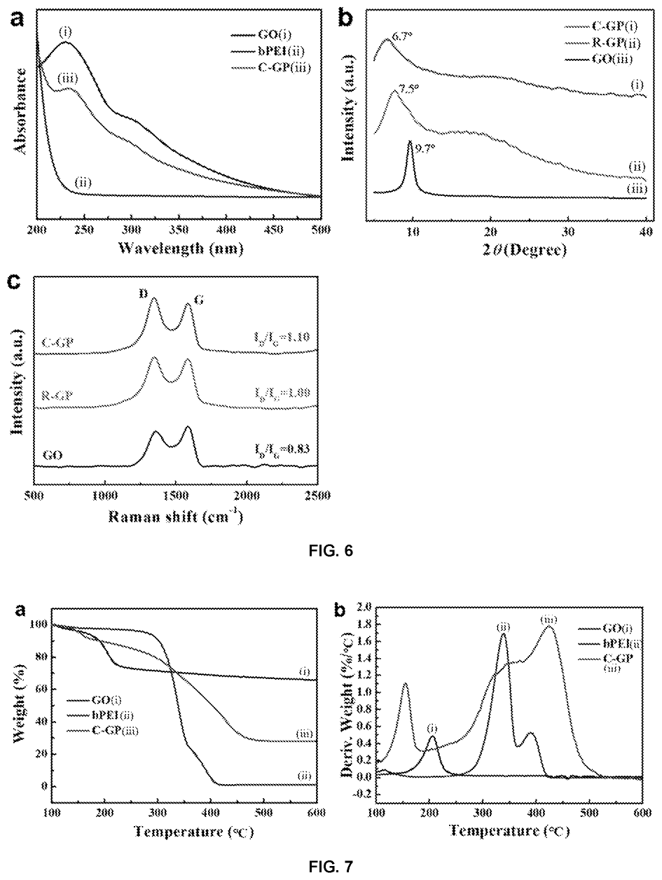

Further analyses, with UV-vis spectroscopy (FIG. 6a), XRD (FIG. 6b), and Raman spectroscopy (FIG. 6c), confirm that the beads are composites of GO and bPEI.

Two absorption bands located at 230 and 297 nm in the GO UV-vis spectrum (FIG. 6a) are due to C═C and C═O bonds, respectively. The absorption increases rapidly below ˜225 nm in the bPEI curve. The C-GP spectrum exhibits superposed features of the GO and bPEI absorption curves, confirming the incorporation of the bPEI and GO constituents.

C-GP and R-GP beads show XRD peaks at 2θ=6.7° and 7.5°, respectively, which are smaller than that of GO (2θ=9.7°), as shown in FIG. 6b. These peaks are attributed to stacked layers of Carbon atoms in the GO. According to Bragg's law, the interlayer distance is 1.31, 1.18 and 0.95 nm for C-GP, R-GP and GO, respectively. The increase in interlayer spacing in the self-assembled beads is attributable to the introduction of bPEI molecules between the GO nanosheet layers during the self-assembly process.

Raman spectra of C-GP and GO (FIG. 6c) show two similar peaks at the same location, implying the presence of GO in C-GP beads. The intensity ratio of D and G band (I_{D}/I_{G}) in the C-GP spectrum is higher than in the GO spectrum, indicating an increase of defects on the GO nanosheets. This may be attributed to the reduction of GO after reacting with bPEI.

Further, we found that binding of bPEI polymers by the GO dramatically increased the zeta potential of GO from −36.1±3.2 mV to +27.0±0.5 mV and +25.8±2.2 mV for R-CP and C-GP complexes, respectively (FIG. 5d). The pure GO nanosheets have many carboxyl groups, resulting in a highly negatively charged surface (and negative zeta potential), which allows the binding of positively charged bPEI polymers by electrostatic interactions to result in cationic R-GP and C-GP beads (Chen, B. et al., J. Mater. Chem. 2011, 21, 7736-7741; and Mallick, A., Nandi, A. & Basu, S., ACS Appl. Bio Mater. 2018, 2, 14-19). From the TGA curves, with final weight loss of GO and C-GP beads of 34.5% and 72.0%, respectively (FIG. 7), the content of bPEI in C-GP was calculated to be ˜57.6 wt % which is consistent with the CNH elemental analysis (Table 2).

TABLE 2
The CNH elemental analysis of the as-prepared products.

| | C (wt. %) | N (wt. %) | H (wt. %) |
|---|---|---|---|
| GO | 42.7 | 0.9 | 3.0 |
| bPEI | 52.8 | 31.3 | 12.2 |
| R-GP | 51.7 | 17.4 | 6.2 |
| C-GP | 49.7 | 14.9 | 5.5 |

### Example 4. Biocompatibility of C-GP Beads

The biocompatibility of C-GP beads (prepared in Example 2) was investigated in vitro and in vivo.

### Bead In Vitro Cytocompatibility Assay

The cytotoxicity of the as-prepared beads toward 3T3 cells was evaluated with MTT assay. 200 μL samples of 3T3 cells suspension in DMEM were seeded into wells of a 96-well plate at 1×10⁴ cells per well, and incubated for 24 h at 37° C. in 5% CO₂. The medium in the test condition wells was then replaced with 200 μL of extraction solution of beads, previously prepared by immersing one bead (˜1.0 mg) in 1.0 mL DMEM solution for 24 h or 72 h at 37° C. Medium in the control wells was replaced with 200 μL of fresh DMEM solution without additional treatment. After incubation for another 24 h, the DMEM in all wells was removed and replaced with 200 μL of MTT solution (1.0 mg/mL, in DMEM). After incubation for another 4 h, the MTT solution was removed and DMSO (100 μL) was added to dissolve the internal purple formazan crystals. The cell viability was measured by reading OD at 570 nm using a TECAN microplate spectrofluorometer:

$$Cell viability \% = \frac{{OD}_{samplewell}}{{OD}_{controlwell}} \times 100 \% \qquad ( 1 )$$

All the assays were performed in triplicate.

### Zebrafish Experiment

Zebrafish (Danio rerio) were housed in the NTU Experimental Medicine Building (EMB) zebrafish facility with a 14 h light/10 h dark cycle with a power density of 7.53 W/cm². The embryos used for the experiments were produced by adult spawning. Typically, one male and two females were transferred into a tank with removable partition to separate male and females and kept overnight. Spawning was triggered by removing the partition in the morning with light. The fertilized embryos were collected at 2 hpf. The healthy fertilized embryos were kept and staged at standard conditions according to Kimmel et al. (Kimmel, C. B. et al., Dev. Dyn. 1995, 203, 253-310). In a typical experiment, embryos at 6 hpf or larvae at 7 dpf (n=30) were distributed into a petri dish with 5 mL zebrafish E3 embryo medium (5 mM NaCl, 0.17 mM KCl, 0.33 mM CaCl₂, 0.33 mM MgSO₄; pH=7.2). To determine the toxicity of the as-prepared beads, one or ten beads were added into the petri dish and incubated with the zebrafish embryos or larvae for three days. Control embryos or larvae were incubated in E3 medium without beads. Zebrafish embryos or larvae were monitored and photographed live using a Leica MZ16FA microscope at 24 hours post exposure (hpe), 48 hpe, and 72 hpe to determine the survival rate of the fish embryos and larvae. Tricaine (0.02% in E3 medium) was used for anesthesia when required.

For adult zebrafish (age: 3 months) experiments, 20 zebrafish (male:female=1:1) were housed in a plastic aquarium equipped with an air pump with 2 L of water for over 10 days, and they were fed twice a day with the same amount of fishmeal (around 2 wt % of zebrafish biomass). 10 beads were added into the aquarium as the experimental group while an aquarium without beads served as the control group. To quantitatively and qualitatively check the quality of the water, digital photos were recorded, and optical density (OD) was measured at 600 nm wavelength. All animal procedures in this study comply with the National Advisory Committee For Laboratory Animal Research (NACLAR) Guidelines set out by the Agri-Food and Veterinary Authority (AVA) of Singapore and were overseen by the NTU Institutional Animal Care and Use Committee (IACUC) (Protocol Number: A19030).

### Results and Discussion

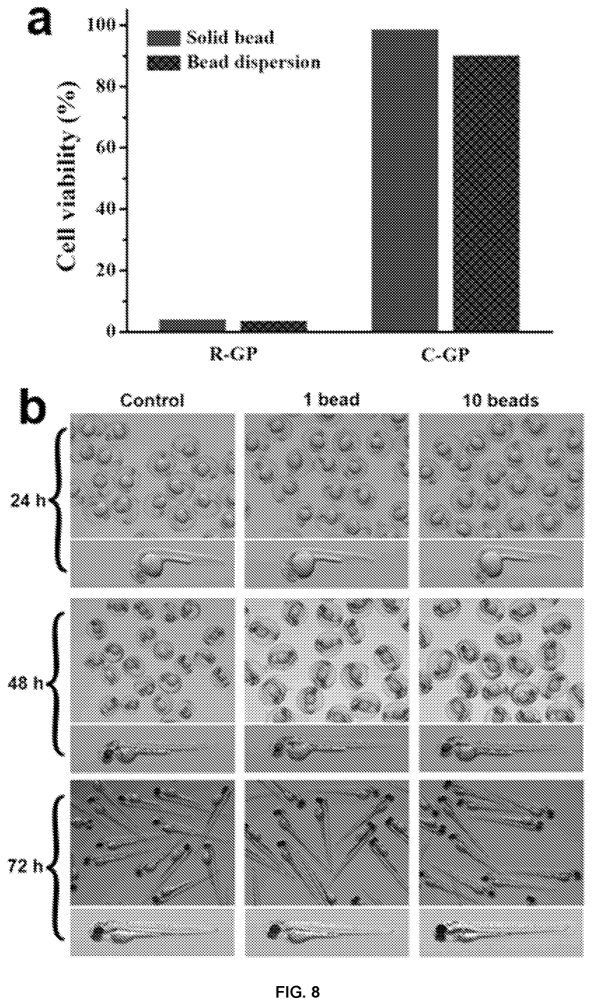

The in vitro viability of 3T3 fibroblast cells after exposure to the beads was tested with MTT assay. The assay indicates that the C-GP beads have no toxicity even when ground into fine powder (FIG. 8a). This good biocompatibility of C-GP beads is due to the crosslinking reaction between bPEI and GO, which prevents leaching and dissolution of bPEI which is very toxic toward 3T3 cells. FIG. 8a also shows that without the crosslinking step, (raw) R-GP beads killed almost all (>95%) of the 3T3 cells.

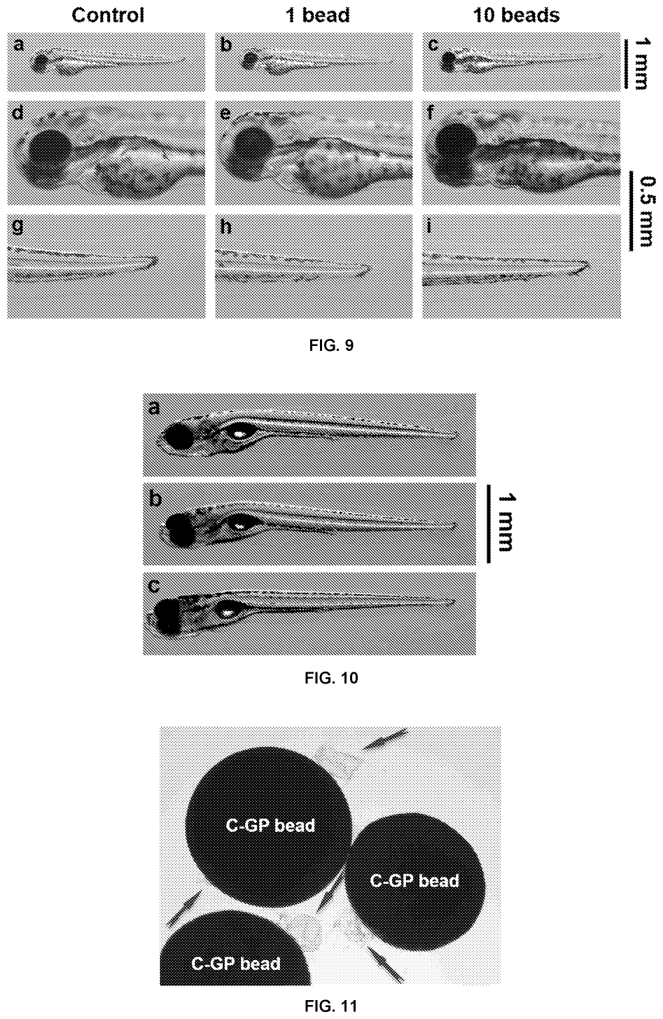

We also performed in vivo testing with zebrafish, a popular vertebrate model for toxicity screening and fish farming applications because of their low-cost effectiveness, fast development, similarity to food fish species, and their optically transparent small body. We, therefore, studied the toxicity and application in aquaculture of the as-prepared C-GP beads using the zebrafish model. The beads-induced toxicity for zebrafish embryos was assessed based on a scoring spectrum introduced by O. Bar-Ian et al. (Bar-Ilan, O. et al., Small 2009, 5, 1897-1910) with modifications. Zebrafish survival percentage and morphological malformations were measured and photographed after various exposure times (24, 48 and 72 h) and number of beads (1 and 10 beads/5 mL E3 medium, corresponding to ˜200 and 2000 μg/mL, respectively) using both zebrafish embryos (6 hours post fertilization, 6 hpf) and zebrafish larvae (7 days post fertilization (7 dpf)). Our results indicate that the zebrafish embryos survival rate is 97% even when treated with 10 beads for 3 days, which suggests that our C-GP beads are biocompatible with zebrafish embryos (Table 3). As shown in FIG. 8b, all embryos successfully hatched from their chorions by 72 hpe. At 24 hpe, both the control and beads-treated embryos (both inside the chorion and dechorionated) exhibited normal development of eyes, tail, brain, and otoliths. As the incubation time progressed to 72 hpe, the beads-treated embryos in all experimental groups showed normal pigmentation, heart, spinal cords, no axial curvatures, and no hatching delay (FIG. 9). Normal development was also observed with zebrafish larvae (7 dpf) (FIG. 10). These results suggest that the crosslinked beads are not toxic. It is also interesting that we observed that these beads can also adsorb contaminating material (zebrafish eggshell) during the incubation period (FIG. 11). The zebrafish embryos and adult zebrafish test results suggest that the C-GP beads exhibit excellent biocompatibility and have potential applications in the aquaculture industry.

TABLE 3
Survival of zebrafish after 24, 48, and
72 h exposure at different beads amount.

| Zebrafish | Beads | Surviving zebra fish (%) | | |
|---|---|---|---|---|
| stage | amount | 24 hpe^{a} | 48 hpe | 72 hpe |

| | | | | |
|---|---|---|---|---|
| 6 hpf^{b} | 0 | 100% | 100% | 97% |

| | | | | |
|---|---|---|---|---|
| 1 | bead | 100% | 100% | 100% |
| 10 | beads | 100% | 97% | 97% |

| | | | | |
|---|---|---|---|---|
| 7 dpf^{c} | 0 | 100% | 100% | 100% |

| | | | | |
|---|---|---|---|---|
| 1 | bead | 100% | 100% | 100% |
| 10 | beads | 100% | 100% | 100% |

^{a}hpe: hours post exposure.
^{b}hpf: hours post fertilization.
^{c}dpf: days post fertilization.

Therefore, the crosslinked beads showed no toxicity in in vitro and in vivo studies. The resulting C-GP beads can be used for the eradication of bacteria and removal of organic matter from bio-contaminated water.

### Example 5. Antibacterial Properties of Beads

We next investigated the dynamic antibacterial activity of raw and crosslinked beads toward bacteria using time-kill assay. E. coli contaminated water (˜10⁸ CFU/mL) was incubated with R-GP and C-GP (2 beads/10 mL, prepared in Example 2) for defined periods (30 min to 5 h) before colony-counting. The E. coli concentration used in this assay, which is ˜10⁸ CFU/mL, is much higher than the typical concentrations in contaminated water (normally around 10⁴-10⁶ CFU/mL, Wang, Y. et al., ACS Nano 2015, 9, 10142-10157; and Laxman, K. et al., Desalination 2015, 362, 126-132).

### Bacteria Killing Performance and Log Reduction Calculation

The antibacterial activity of the beads was assessed against E. coli. E. coli cells were cultured in MHB medium (10 mL) at 37° C. overnight with continuous shaking at 200 rpm, and were harvested at the mid-logarithmic phase by centrifugation (2000 rpm, 5 min). The centrifuged pellet was then washed with PBS twice to remove the residual nutrition, and diluted to a final concentration of 10⁸ CFU/mL in water. Two beads (˜2 mg) after 5 min sonication were put into 10 mL of the as-prepared E. coli suspension in a 15 ml falcon tube and incubated at 37° C. under 200 rpm shaking speed. 100 μL samples were removed after 1 h and 3 h for colony counting to measure log reductions in bacteria counts. Briefly, a series of 10-fold bacteria dilutions were spread onto LB agar plates. After incubation at 37° C. overnight, the colonies of both control (without beads treatment) and experimental groups (with beads treatment) were counted to determine the log reduction by the equation below:

$$log reduction = log [ \frac{{CFU}_{control}}{{CFU}_{sample}} ] \qquad ( 2 )$$

Each experiment was performed in triplicate.

E. coli Morphology Change

FESEM was used to study the morphology changes of E. coli after incubation with the as-prepared beads. After incubation with the beads, bacteria were fixed in 2.5% glutaraldehyde at 4° C. overnight, followed by dehydration in a graded concentration ethanol series (25%-100%) and dried at room temperature for 24 h. The as-prepared samples were then coated with platinum before imaging.

### Leaching Test by HPLC Performance

10 R-GP or C-GP beads were immersed in 10 mL of DI water for 3 days. The resulting solutions were sampled for leaching tests. bPEI aqueous solution at concentration of 100 μg/mL was used for comparison. Buffer A (0.1 vol % of TFA in DI water) and buffer B (0.1 vol % of TFA in MeCN) were prepared. The sample solutions were analyzed by HPLC (Agilent 1200) with a wavelength detector of 210 nm and use of an Eclipse Plus C18 column. The mobile phase was the mixed buffers at a linear gradient of 31%-50% (buffer B/A) in 30 min, with a flow rate of 1 mL/min.

### Results and Discussion

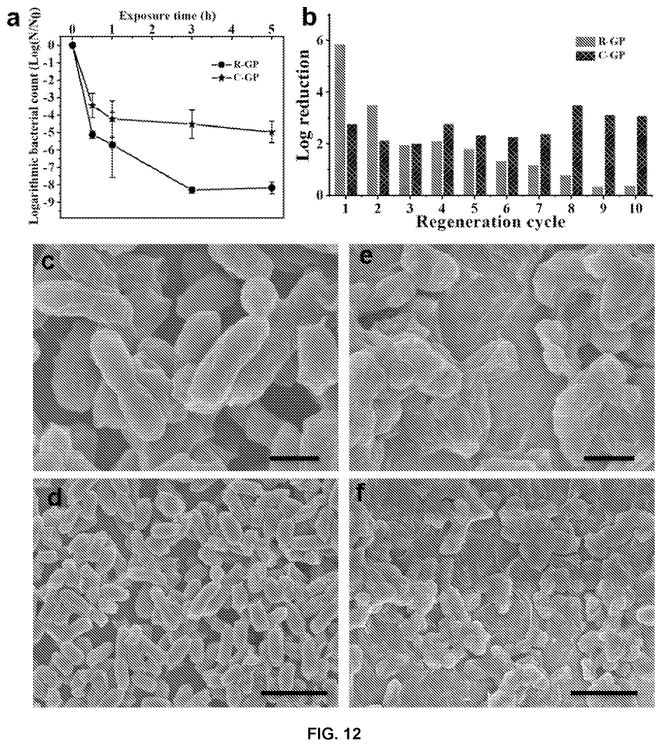

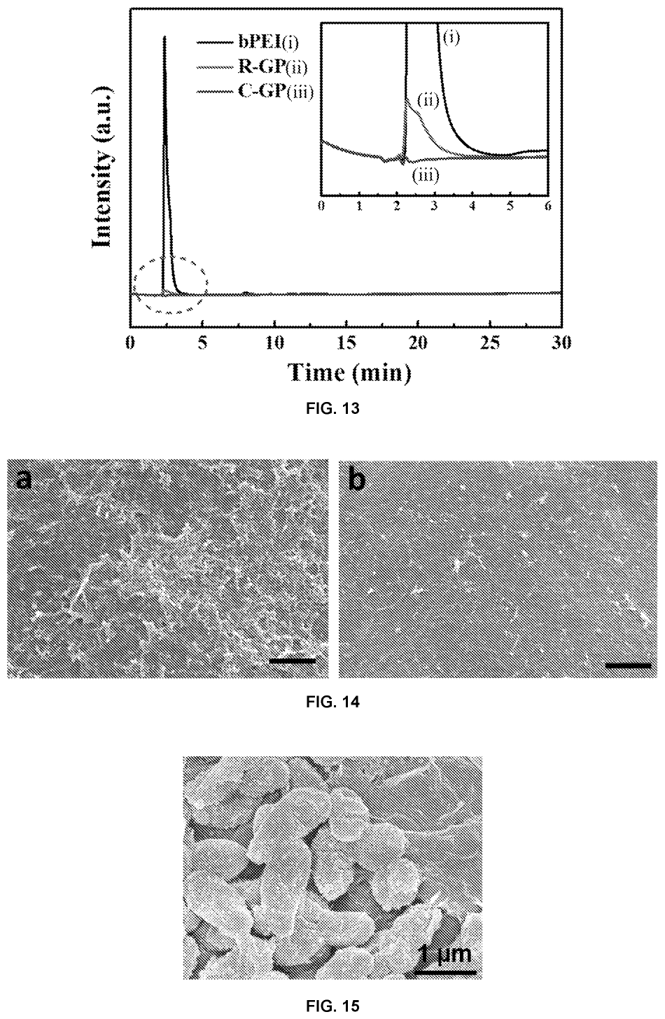

As shown in FIG. 12a, the logarithmic bacterial count of E. coli steadily decreased with incubation time. The C-GP beads can produce a reduction of 3.4 orders (i.e. >99.9%) in the first 30 min, increasing to 4.9 orders (ca. 99.999%) after 5 h of incubation. R-GP beads were significantly more bactericidal, with reduction of 5.1 orders (i.e. >99.999%) within 30 min. No live bacteria were detected after 3 h of incubation with R-GP. The better antibacterial performance of R-GP compared with C-GP beads is presumably due to the leaching of the non-crosslinked bPEI which has good antibacterial activity into the bacterial suspension (Yeo, C. K. et al., ACS Appl. Mater. Interfaces 2018, 10, 20356-20367; and Fan, Z. et al., ACS Appl. Nano Mater. 2018, 1, 1811-1818). This interpretation is supported by the detection of bPEI polymer in the surrounding media by HPLC characterization after immersion of R-GP beads in DI water (FIG. 13).

The recyclability and stability of the C-GP beads are critical for their practical applications. CTAB detergent (0.01 M) was found to be an efficient regeneration agent for C-GP beads. No bacteria were observed on the surface of beads after washing with CTAB and DI water (FIG. 14). We found that the C-GP beads retained their antibacterial performance with a log reduction of around 3.0 (i.e. ˜99.9%) over at least 10 consecutive use/regeneration cycles (FIG. 12b). However, the R-GP beads showed a significant log reduction decline from 5.8 to 0.3, implying that on the 10th cycle, the R-GP beads could inactivate only about half of the contaminating bacteria. This is presumably due to leaching of bPEI from the R-GP beads, resulting in a loss of the active polymer, as indicated by HPLC characterization.

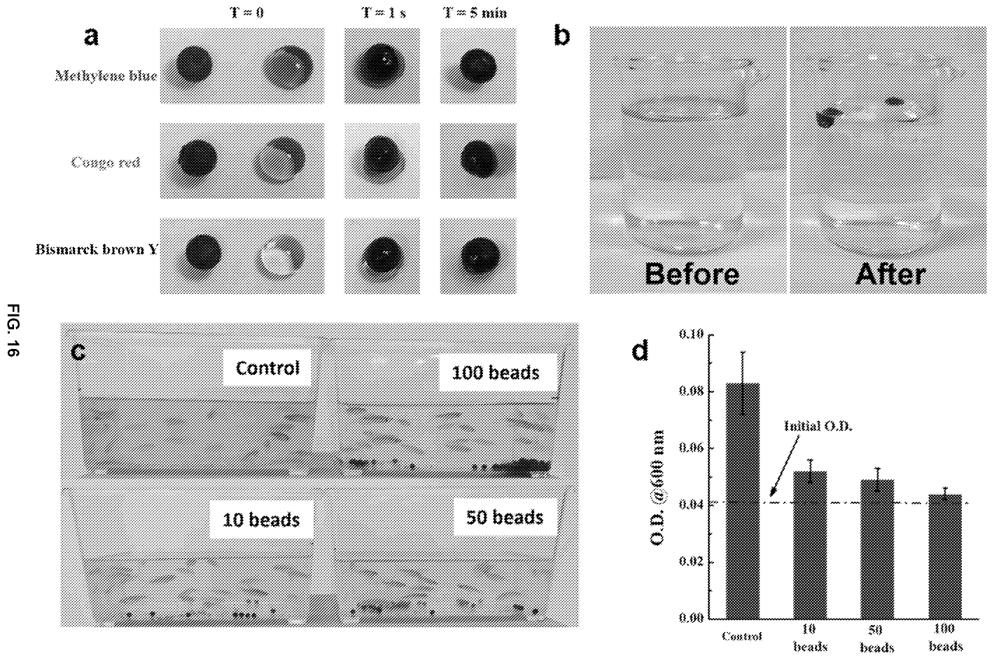

To understand how the beads inactivate bacteria, we used FESEM to examine the morphology change and membrane integrity of E. coli cells after incubation with beads. As depicted in FIGS. 12c-d, the microbial cells in the control group were intact without membrane damage. However, the C-GP beads-treated E. coli cells showed wrinkled cell surfaces (FIGS. 12e-f), and many E. coli cells had become smaller, which may be due to membrane damage and cytoplasm leakage. These results indicate that the E. coli cells suffered significant damage when in contact with the surface of the beads. R-GP beads-treated cells have more severe morphological changes (FIG. 15) than C-GP beads-treated cells, which is consistent with the higher initial bactericidal efficacy of R-GP due to the leaching of free antibacterial bPEI.

### Example 6. Mechanical and Organic Removal Properties of Beads

The high porosity and mechanical stability of the crosslinked beads make them suitable for adsorption of organic matter and toxic components with high adsorption efficiency and good recyclability. A series of adsorption experiments was carried out to assess the organic matter adsorption performance of C-GP beads (prepared in Example 2).

### Adsorption Experiments

Different amounts of beads or other materials were put into 10 mL ammonia solution with an initial concentration of 8.0 ppm for 4 hours and 24 hours. Then, 2.5 mL of solution was transferred to a vial, the ammonia test kit (API®) reagents were added, and the mixture was vortexed for 1 min. After 5 min, the color of the solution was compared with the test kit calibration color card to estimate the ammonia concentration.

### Results and Discussion

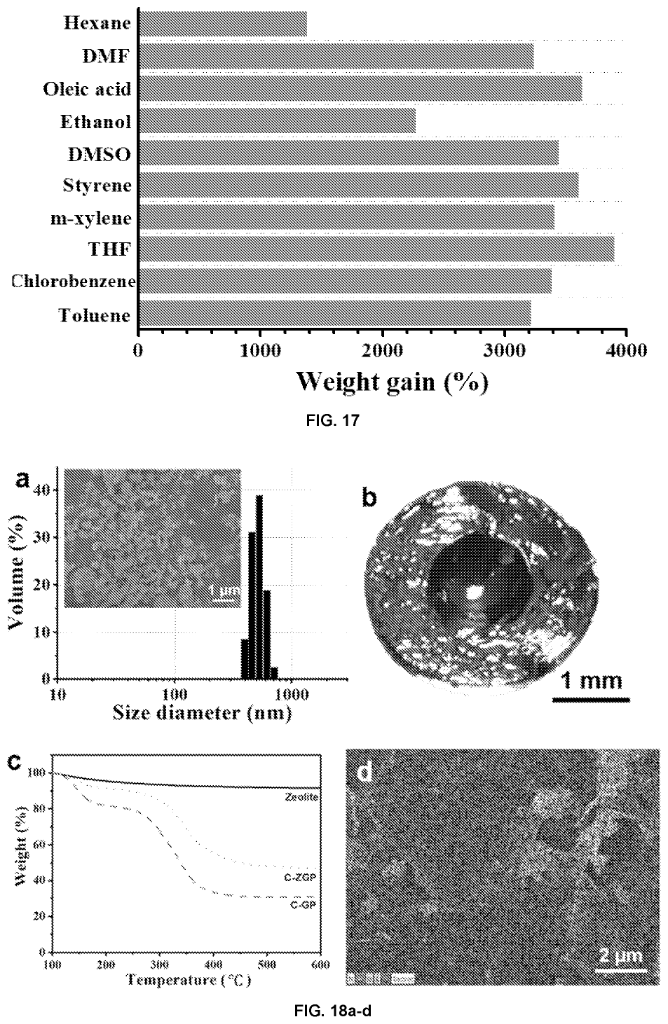

As shown in FIG. 16a, a freeze-dried bead can adsorb a droplet of aqueous dye (surrogate for organic matter) solution within 5 min of contact; this is probably due to its highly porous structure and high hydrophilicity (FIGS. 3e-g). In addition, the beads showed outstanding adsorption behavior and capability towards various organic solvents and chemicals such as hexane, DMF, chlorobenzene, etc., with adsorption capacity in the range 13.8 to 39.0 times the bead mass (FIG. 17). We also demonstrated oil/water separation in adsorption experiments with a beaker containing hexane (dyed with Sudan I) floating on the water surface, as shown in FIG. 16b; the freeze-dried C-GP beads exhibited rapid adsorption of hexane. These results show that C-GP beads have potential for applications requiring facile and rapid removal of organic matter, resulting from the porous structure. The highly porous structure and abundant functional groups of the crosslinked beads give them high adsorption capacity towards various forms of organic matter such as fish waste.

To qualitatively simulate application in aquaculture with fish excretion and unconsumed feed, we applied our as-prepared beads in an aquarium and incubated them with adult zebrafish for 10 days. The water in the aquariums with C-GP beads was much clearer than the water in the untreated control aquarium (FIG. 16c). The cloudy water in the control group was mainly caused by fish food residues and fecal sludge; enough of these were adsorbed by the C-GP beads to make an obvious qualitative improvement in water quality. To quantitatively measure the cloudiness of water, OD was recorded for the aquarium water samples after 10 days. The OD was 0.083, 0.052, 0.049, and 0.044 for the control, 10 beads, 50 beads, and 100 beads groups, respectively (FIG. 16d). No fish died in any of the study groups, and no beads were found to have cracked during the study period.

### Example 7. Preparation of C-ZGP Beads

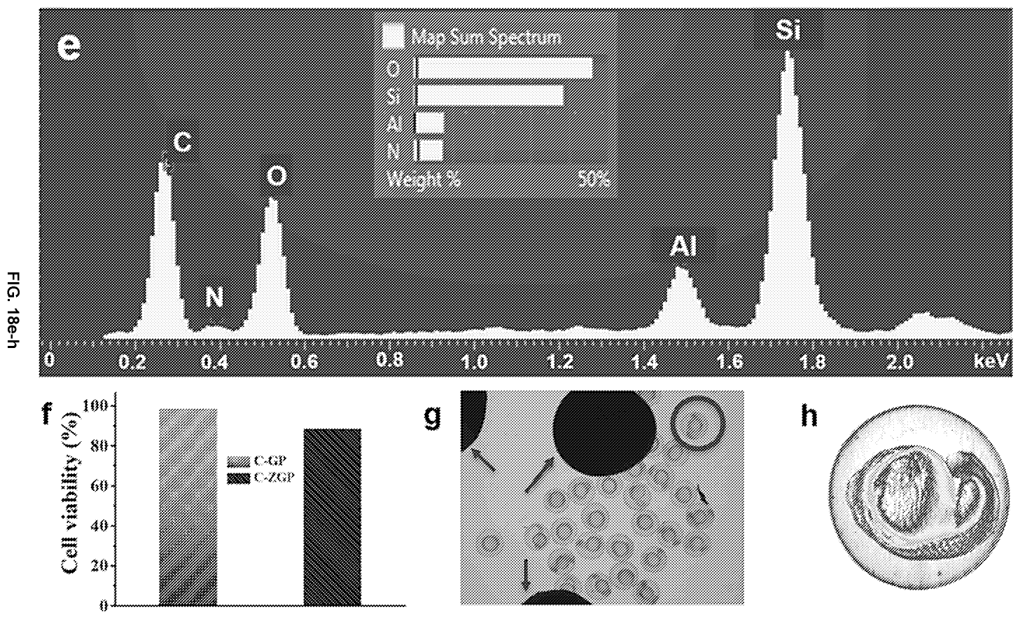

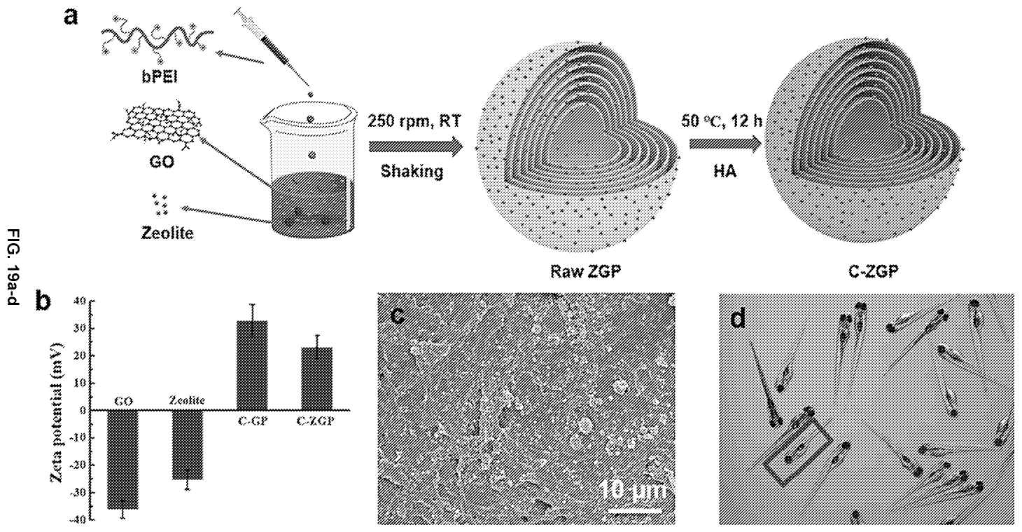

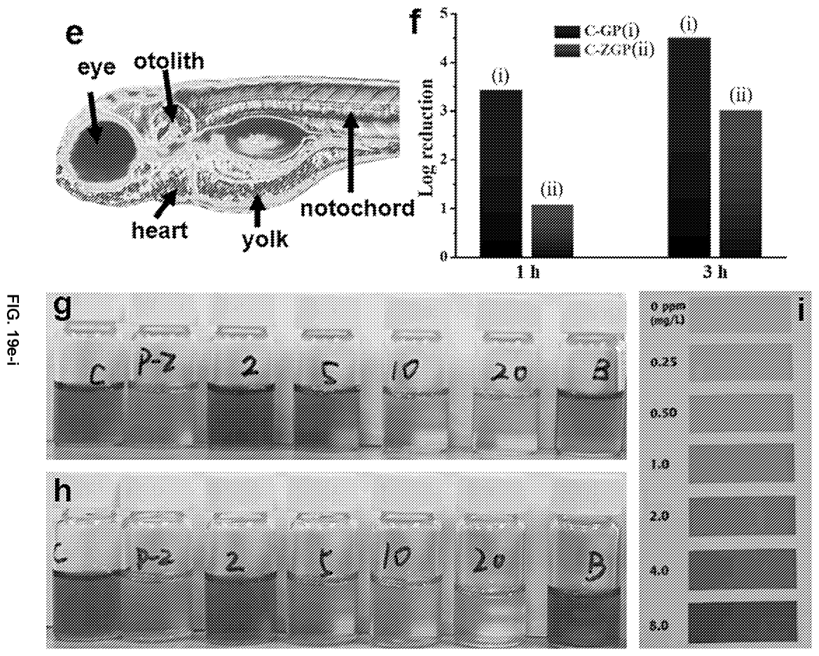

To illustrate that it is easy to add further functionality to our beads and to further explore the further functionalization of the beads, we incorporated zeolite nanoparticles (ZNPs) with sizes in the range of 390 to 720 nm (FIG. 18a) into the GO suspension to prepare crosslinked zeolite/GO/bPEI (C-ZGP) beads to also scavenge TAN. The preparation steps for C-ZGP beads are shown in FIG. 19a. The primary zeolite stone particles were ground into nanoscale particles and added into the GO suspension (Zeolite:GO, 1:1 mass ratio). Raw ZGP (R-ZGP) beads were formed by a procedure similar to that for R-GP beads (FIG. 1a, as described in Example 2). The (ionic) crosslinking was performed by immersing the R-ZGP beads into 1.0 mg/mL HA solution and prolonged heating.

Specifically, the preparation of crosslinked zeolite/GO/bPEI (C-ZGP) beads followed the same procedure as C-GP beads as described in Example 2, except 10.0 mg/mL of zeolite nanoparticles were added into the GO suspension prior to the self-assembly process. The crosslinking procedure was modified by addition of 1.0 mg/mL HA for 12 h at 50° C. prior to the crosslinking reaction. The crosslinked beads were washed by sonication with DI water for 10 min to remove any residual reactant before testing.

### Results and Discussion

We demonstrate herein a facile preparation multi-component of C-ZGP beads with both antibacterial activity and ammonia adsorption capability via the dd-LBL process followed by a crosslinking reaction. The amine-group-rich bPEI not only acts as the driving force but also the antibacterial component as it is positively charged. The ZNPs which are homogenously anchored on the beads surface serve as the ammonia removal component. The ZNPs are intercalated between the GO layers while the high molecular weight HA electrostatically binds the bPEI.

### Example 8. Characterization of C-ZGP Beads

The C-ZGP beads prepared in Example 7 were characterized.

### Size Distribution and Zeta Potentials

Zetasizer Nano-ZS (Malvern Panalytical) was used to measure the size distribution of zeolite nanoparticles and zeta potentials.

### Results and Discussion

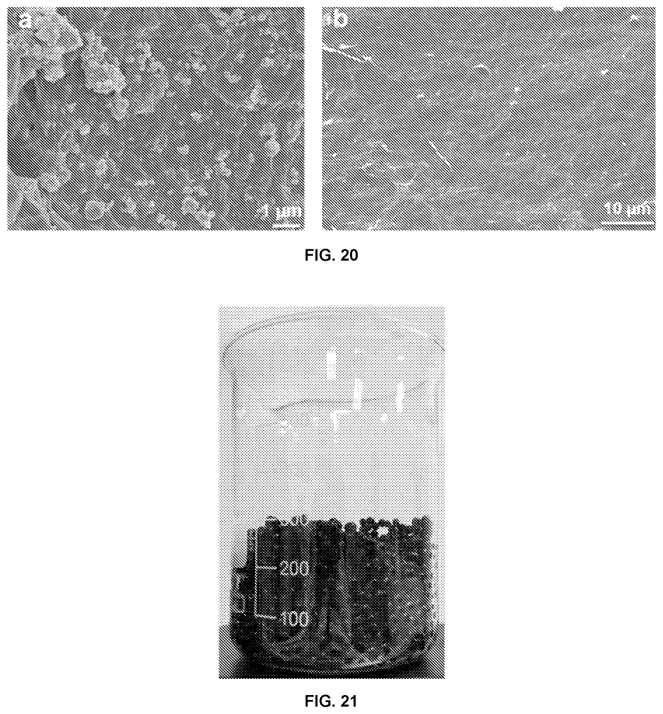

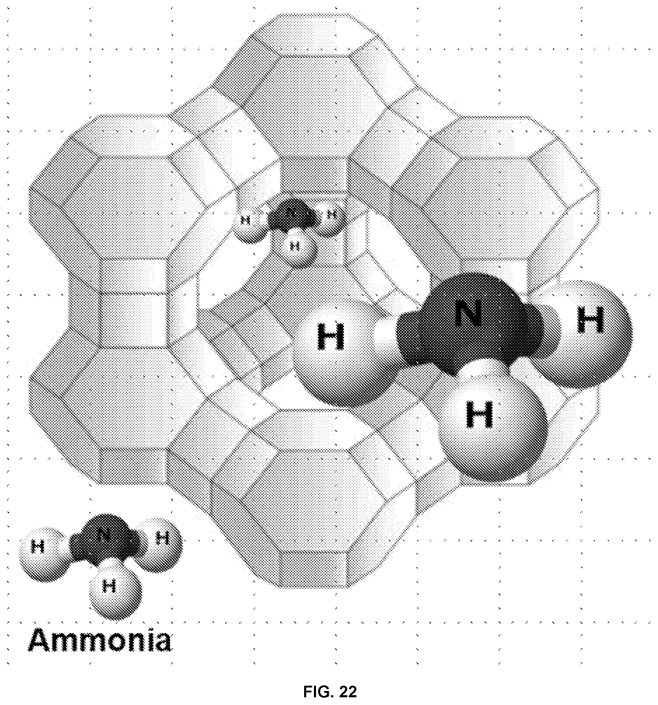

The C-ZGP beads have a hollow-core and layered-shell structure (FIG. 18b) that is similar to that of C-GP beads (FIG. 2b), which indicates that the addition of ZNPs does not affect the bead formation process. With negatively charged ZNPs involved in the beads self-assembly process, the crosslinked C-ZGP complex is positively charged, with zeta potential of +23.2±4.2 mV (FIG. 19b) which is lower than that of C-GP beads (+33.0±5.8 mV). The surface microstructure of the as-prepared C-ZGP beads was investigated by FESEM (FIGS. 19c and 20a). Unlike C-GP beads which have smooth surfaces (FIGS. 4a and 20b), the surface of C-ZGP beads was rough and anchored with ZNPs (FIG. 19c), and most of their size is several hundred nanometers which is consistent with the measurement with Nano-ZS particle sizer (FIG. 18a). FIG. 18c shows that the final weight of zeolite, C-GP, and C-ZGP beads was 91.3%, 31.3%, and 45.8%, respectively. Combined with the TGA curves of GO and bEPI, the content of GO, bPEI, and zeolite in C-ZGP beads was determined to be 32.1, 43.7, and 24.2 wt %, respectively, according to the TGA curves (FIGS. 7 and 18c). In addition, from the analysis of FESEM-EDX elemental mapping (FIGS. 18d-e), the bPEI and zeolite are widely and homogeneously distributed on the surface of the C-ZGP beads, which is similar to the elemental mapping results for C-GP. Due to the facile preparation method, it is very easy to scale-up the process and make large amount of such C-ZGP beads (FIG. 21).

### Example 9. Ammonia Removal, Biocompatibility and Antibacterial Properties of Zeolite-Containing G-ZGP Beads

Besides bacteria, the presence of ammonia in an aquaculture system is another threat as it is toxic to the fishes. We next investigated the adsorption of ammonia by different amounts of C-ZGP beads (prepared in Example 7); pristine zeolite stones and C-GP beads (prepared in Example 2) were also tested for a comparison. In vitro and in vivo studies on zeolite-containing G-ZGP beads (prepared in Example 7) were performed by following the protocol in Example 4.

### Ammonia Adsorption Experiments

Different amounts of beads or other materials were put into 10 mL ammonia solution with an initial concentration of 8.0 ppm for 4 h and 24 h. Then, 2.5 mL of solution was transferred to a vial before the addition of the ammonia test kit (API®) reagents, and the mixture was vortexed for 1 min. After 5 min, the color of the solution was compared with the test kit calibration color card to estimate the ammonia concentration.

### Results and Discussion

The MTT assay indicates that the in vitro viability of 3T3 fibroblast cells are not affected by the C-ZGP beads, with cell viability of over 85% (FIG. 18f), which is slightly lower than the value obtained with the C-GP beads (over 99%). To further examine the biocompatibility of the as-prepared C-ZGP beads, we incubated them with zebrafish embryos (6 hpf) in E3 medium for 5 days. All embryos successfully hatched from their chorions (FIG. 19d) and exhibited overtly normal development of organs such as swim bladder, otolith, eye, etc., with no observable organ defects (FIG. 19e). The development of embryos of the experimental group behaved the same to those in control group. These results suggest that the crosslinked C-ZGP beads are, like C-GP beads, essentially non-toxic towards embryos, which is essential for the practical application in aquaculture.

The C-ZGP beads have reduced antibacterial properties towards E. coli with log reductions of 1.1 (i.e. >90%) and 3.0 (i.e. 99.9%) after incubation times of 1 h and 3 h, respectively (FIG. 19f), which means a rapid killing efficiency against bacteria. The log reduction increased to 4.5 and 3.0 with time extended to 3 h of incubation for C-GP and C-ZGP beads, respectively. The reduced antibacterial performance of C-ZGP beads compared with C-GP beads is attributable to the reduction in bead surface charge due to the presence of negatively charged zeolite nanoparticles which interact with positively charged bPEI. Branched-PEI inactivates bacteria through its high cationicity, which electrostatically complexes with negatively charged phospholipids, and will perturb bacterial membrane. Being a cation exchanging material, the zeolite nanoparticles will adsorb some of the bPEI groups, evident in the lower zeta potential of the C-ZGP beads and will thus reduce the overall antibacterial activity. FIG. 18g shows the C-ZGP beads incubated with zebrafish embryos in E3 medium. FIG. 18h shows that the embryos at 1 dpf were well fertilized.

The adsorption of TAN was assessed using a colorimetric API kit with different amounts of C-ZGP beads; pristine zeolite particles and C-GP beads (without zeolite) were also tested for comparison (FIG. 19i). The NH₃ was converted to NH₄⁺ when the concentration is in ppm level (Table 2), and API® ammonia test kit measures the total amount of NH₃ and NH₄⁺ (or the TAN). The TAN concentration for pristine zeolite particles (2^{nd} bottle) decreased from 8.0 ppm (at time t=0) to 0.25 ppm within 4 h and then plateaued even with prolonged measurement to 24 h (FIGS. 19g-h). The adsorption capacity of the pristine zeolite was calculated to be 1.02 mg/g (Table 4). In the test condition using 5 C-ZGP beads (4^{th} bottle), the TAN concentration decreased from 8.0 ppm to 0.25 ppm after 24 h even though the zeolite mass was only 9.4 mg (compared with 75.8 mg pristine zeolite in the first bottle). The calculated adsorption capacity of the C-ZGP beads was 8.24 mg/g, over 8 times that of the pristine zeolite (1.02 mg/g). This may be attributed to the ball milling process which converted the millimeter-sized pristine zeolite particles into sub-micron zeolite nanoparticles, resulting in a much higher surface to volume ratio. This might indicate that the TAN is adsorbed to the outer surface of the zeolite, and hardly diffuses into the mesoporous matrix of the zeolite over the time span investigated. Thus, further modification by adding negatively charged ZNPs to the GO suspension and crosslinking with HA (Mw=1,100,000) creates non-toxic C-ZGP beads that can simultaneously remove TAN. Addition of ZNPs during the bead formation process and subsequent chemical crosslinking with HA makes these beads suitable for removal of TAN while preserving the excellent antibacterial activity and biocompatibility.

TABLE 4
TAN concentration after treatment with different
materials and their 24 h TAN absorption.

| | | | | 2 C- | 5 C- | 10 C- | 20 C- | 20 C- |
|---|---|---|---|---|---|---|---|---|
| | | | Pristine | ZGP | ZGP | ZGP | ZGP | GP |
| Sample | | Control | zeolite | beads | beads | beads | beads | beads |
| Mass (mg) | | — | 75.8 | 3.8 | 9.4 | 18.9 | 37.8 | 35.6 |
| 4 | h | 8.0 | 0.25 | 4.0 | 1.0 | 0.25 | 0 | 8.0 |
| 24 | h | 8.0 | 0.25 | 1.0 | 0.25 | 0 | 0 | 8.0 |

| | | | | | | | |
|---|---|---|---|---|---|---|---|
| Absorbed | N.A. | 1.02 | 18.42 | 8.24 | 4.23 | 2.11 | 0 |
| TAN (mg/g) | | | | | | | |

Therefore, we have prepared multifunctional C-GP and C-ZGP beads that could combine negligible toxicity, excellent antibacterial activity and contaminant scavenging, via a 2-step process involving I) a facile self-assembly of GO nanosheets into a hollow-core macrostructure, followed by II) a crosslinking reaction step to prevent leaching of bPEI. These non-leachable beads showed excellent biocompatibility toward 3T3 cells and zebrafish embryos, larvae and adults. Crosslinking also improves the mechanical strength of the beads. The large size (millimeter) scale of the beads is important to prevent ingestion by fish. These beads are durable and can be easily regenerated by a simple washing step; their antibacterial activity is preserved over at least 10 use/regeneration cycles without apparent performance decline.

The quaternary amine groups of the bPEI are not only the functional groups for the self-assembly with GO but also serve as the active component for inactivating bacteria. The amine-group-riched bPEI and ZNPs, which are homogenously conjugated and distributed on the beads surface, endow the as-prepared C-ZGP beads with excellent antibacterial performance and ammonia removal capability. The antibacterial activity is good, with over 99.9% killing of E. coli in 30 min even with ultrahigh (˜10⁸ CFU/mL) E. coli concentration, and outperform the commercial zeolite for ammonia removal. The combination of cationic bPEI and hydrophobic GO gives it very good adsorption capacities for various forms of organic matter, both hydrophilic and hydrophobic. Incorporation of zeolite in the beads results in a somewhat reduced bacterial inactivation with log reduction of 3.0 after 3 h of incubation, but adds effective scavenging activity against TAN.

Another advantage of these free-standing beads is that they can be easily handled and do not require any supporting equipment for functioning and are effective and quick in their actions. These bacteria-, organic waste- and ammonia-removal beads which are non-toxic to the zebrafish can potentially be used in urban high-density RAS and in the transportation of fishes across long distances. For application in RAS with larger fish, the beads should and can be made larger, or could be enclosed in containers or cartridges which permit water passage but prevent fish access.

Taken together, we have developed a platform for making functional beads that are non-toxic and inactivate bacteria and waste component such as TAN and organic matter from water in recirculating aquaculture systems. Due to crosslinking of the GO carboxyl groups with bPEI amines, the beads here are mechanically stabilized while the toxic antibacterial component bPEI is prevented from leaching out of the beads, thus ensuring non-toxicity. They can be regenerated many times using a solution of a cationic surfactant.

The large size (millimeter scale) of these cationic beads prevents their ingestion by fish. The cationic beads rapidly inactivate bacteria by a contact kill mechanism. The beads may also remove the organic matter. The incorporation of zeolites into the beads makes them scavenge TAN from the water as well. Their combined adjustable size and mechanical strength, antibacterial activity, and adsorption capacity for contaminants offer a practical and effective solution for various environmental applications, such as aquaculture and wastewater treatment, pollutant removal, and aquaculture application.

1. A composite material in the form of a bead, comprising:
a polyethyleneimine;
graphene oxide; and
zeolite nanoparticles, wherein:
the bead has a hollow core and a layered shell structure comprising a plurality of layers of graphene oxide and a plurality of layers of polyethyleneimine, where any two layers of graphene oxide are separated by a layer of polyethyleneimine and the zeolite nanoparticles are intercalated between the plurality of graphene oxide layers; and
the polyethyleneimine is crosslinked by a negatively charged crosslinking agent.

2. A composite material in the form of a bead, comprising:
a polyethyleneimine; and
graphene oxide, wherein:
the bead has a hollow core and a layered shell structure comprising a plurality of layers of graphene oxide and a plurality of layers of polyethyleneimine, where any two layers of graphene oxide are separated by a layer of polyethyleneimine; and
covalent bonds are formed between the polyethyleneimine and the graphene oxide to crosslink the polyethyleneimine to the graphene oxide.

3. The composite material according to claim 1, wherein the weight to weight ratio of the graphene oxide to the zeolite nanoparticles is from 1:1 to 1.4:1.

4. The composite material according to claim 1, wherein the weight to weight ratio of the polyethyleneimine to graphene oxide is from 1:1 to 1.4:1.

5. The composite material according to claim 1, wherein the zeta potential of the composite material is from +19 to +28 mV.

6. The composite material according to claim 1, wherein the composite material has an ammonia adsorption capacity of from 7 to 19 mg/g.

7. The composite material according to claim 2, wherein the zeta potential of the composite material is from +27 to +39 mV.

8. The composite material according to claim 1, wherein the polyethyleneimine is a branched polyethyleneimine.

9. The composite material according to claim 1, wherein the negatively charged crosslinking agent is hyaluronic acid.

10. (canceled)

11. A method of aquaculture comprising the steps of:
(a) providing an aquaculture medium; and
(b) placing a plurality of beads of a composite material according to claim 1 into the aquaculture medium.

12. A method of manufacturing a composite material according to claim 1, wherein the method comprises the steps of:
(i) providing a mixture comprising a suspension of graphene oxide and zeolite nanoparticles in a liquid;
(ii) adding a plurality of droplets of polyethyleneimine to the mixture to provide beads comprising graphene oxide, zeolite nanoparticles and polyethyleneimine; and
(iii) ionically crosslinking the polyethyleneimine in the beads with a negatively charged crosslinking agent to provide the composite material.

13. The method according to claim 12, wherein the weight to weight ratio of graphene oxide to zeolite nanoparticles in the liquid is from 1:2 to 2:1.

14. The method according to claim 12, wherein the negatively charged crosslinking agent is hyaluronic acid.

15. A method of manufacturing a composite material according to claim 2, wherein the method comprises the steps of:
(i) providing a mixture comprising a suspension of graphene oxide in a liquid;
(ii) adding a plurality of droplets of polyethyleneimine to the mixture to provide beads comprising graphene oxide and polyethyleneimine; and
(iii) covalently crosslinking the polyethyleneimine in the beads to the graphene oxide with a crosslinking agent to provide the composite material.

16. The method according to claim 12, wherein the weight to weight ratio of the graphene oxide to polyethyleneimine is from 2:1 to 1:2.

17. The method according to claim 15, wherein the crosslinking agent is a carbodiimide.

18. A method of aquaculture comprising the steps of:
(a) providing an aquaculture medium; and
(b) placing a plurality of beads of a composite material according to claim 2 into the aquaculture medium.
